(19) United States
(12) Patent Application Publication
(10) Pub. No.: US 2012/0163313 A1
(43) Pub. Date: Jun. 28, 2012

(54) CALL PROCESSING METHOD FOR USE IN MACHINE-TYPE COMMUNICATION TERMINAL

(75) Inventors: Kwang Ryul JUNG, Daejeon (KR); Jae Wook SHIN, Daejeon (KR); Kyung Yul CHEON, Daejeon (KR); Ae Soon PARK, Daejeon (KR)

(73) Assignee: Electronics and Telecommunications Research Institute, Daejeon (KR)

(21) Appl. No.: 13/333,495

(22) Filed: Dec. 21, 2011

(30) Foreign Application Priority Data
Dec. 23, 2010 (KR) 10-2010-0133006

(51) Int. Cl. H04W 72/04

(52) U.S. Cl. 370/329

(57) ABSTRACT

Disclosed is a call processing method for use in a machine-type communication terminal. The call processing method includes transmitting, by a terminal, a radio resource control (RRC) connection request message to a base station, receiving, by the terminal, an RRC connection setup message from the base station, receiving, by the terminal, an uplink (UL) resource allocation grant message from the base station in a state in which a service request message and a buffer status report message are not transmitted to the base station, and transmitting, by the terminal, a message for call processing corresponding to the UL resource allocation grant message. It is possible to rapidly and efficiently perform a call processing procedure and lengthen the life span of the terminal by reducing power consumption of the terminal that uses battery as an energy source.

### CLAIM FOR PRIORITY

This application claims priority to Korean Patent Application No. 10-2010-0133006 filed on Dec. 23, 2010 in the Korean Intellectual Property Office (KIPO), the entire contents of which are hereby incorporated by reference.

### BACKGROUND

1. Technical Field

Example embodiments of the present invention relate to machine-type communication (MTC), and more particularly, to a call processing method for use in an MTC terminal that may optimize call processing of the MTC terminal.

2. Related Art

MTC or machine to machine (M2M) communication is data communication related to one or more entities that do not necessarily include human intervention.

MTC service is a communication field that is rapidly growing all over the world, and is defined in the development direction of next-generation mobile communication technology, even in a mobile communication standard organization such as 3rd Generation Project Partnership (3GPP). The number of MTC terminals is expected to reach about 50 billion in the year 2020, and will be greater than the number of mobile communication terminals to be owned by people, expected to be about 2.7 billion in the year 2020.

MTC service utilizing mobile communication is ongoing and being utilized in various fields. At present, MTC service fields widely using mobile communication are telematics, security, automatic meter reading (AMR), payment, remote maintenance and control (RMC), and the like, and its range of use is extending to health care or consumer devices.

Characteristics of MTC service in 3GPP different from an existing human-centric communication service have been analyzed to be a) low mobility, b) data transmission/reception only during a defined time (time controlled), c) data transmission delay tolerance (time tolerant), d) priority alarm message, e) dedicated service for packet switching (packet switched only), f) low data communication rate (small data transmission), and the like.

As a noticeable point in variation of a terminal and system according to the MTC service, it shall be possible to transmit and receive small amounts of data even in an offline state. As mentioned in 5.5.2 of 3GPP Technical Report (TR) 23.888, it shall be possible to transmit small amounts of data with very efficient resource usage when the MTC device is not attached and not context activated. This means that an MTC server should be able to rapidly receive information transmitted from an MTC terminal using a minimum radio resource and battery. In particular, the promptness of MTC call processing and data transmission is very important in services such as detection of a gas or water leak in smart metering, or critical condition detection in e-Health such as heart failure, falling, or the like. Accordingly, a cell processing procedure for MTC should be rapidly performed.

However, a rapid call processing procedure is not defined in basic data transmission/reception procedures defined in existing international mobile telecommunications (IMT)-advanced systems. Therefore, there is a problem in that call processing may be time-consuming. In addition, there is a disadvantage in that the life span of an MTC terminal using a battery as a main energy source may be shortened because power consumption of the MTC terminal increases when call processing time increases.

### SUMMARY

Accordingly, example embodiments of the present invention are provided to substantially obviate one or more problems due to limitations and disadvantages of the related art.

Example embodiments of the present invention provide a call processing method for use in an MTC terminal that may efficiently and rapidly perform a call processing procedure.

In some example embodiments, a call processing method for use in an MTC terminal in a wireless communication network for providing an MTC service, includes: transmitting, by a terminal, a radio resource control (RRC) connection request message to a base station; receiving, by the terminal, an RRC connection setup message from the base station; receiving, by the terminal, an uplink (UL) resource allocation grant message from the base station in a state in which a service request message and a buffer status report (BSR) message are not transmitted to the base station; and transmitting, by the terminal, a message for call processing corresponding to the UL resource allocation grant message.

The UL resource allocation grant message may include UL resource allocation information corresponding to a message estimated by the base station as a message to be transmitted by the terminal.

The receiving of the UL resource allocation grant message from the base station may include: receiving, by the terminal, the UL resource allocation grant message from the base station before one of an RRC connection setup complete message, an attach request message, a radio link control (RLC) acknowledgement (Ack) message, an authentication response message, an RRC connection reconfiguration complete message, an attach complete message, and application data, is transmitted.

The UL resource allocation grant message may include UL resource allocation information corresponding to messages estimated by the base station as messages to be multiplexed and transmitted by the terminal.

The transmitting of the message for the call processing may include: multiplexing, by the terminal, at least two messages among messages to be sequentially transmitted to the base station for the call processing in a medium access control (MAC) layer; and transmitting the multiplexed messages to the base station.

The transmitting, by the terminal, of the RRC connection request message to the base station may include: including and transmitting control element (CE) information including information from which the base station identifies the terminal.

The CE information may include at least one piece of terminal type information, application data priority information, and service type information, and may be configured in the form of a MAC CE protocol data unit (PDU).

In other example embodiments, a call processing method for use in an MTC terminal in a wireless communication network for providing an MTC service, includes: receiving, by a base station, an RRC connection request message from a terminal; transmitting, by the base station, an RRC connection setup message to the terminal; transmitting, by the base station, a UL resource allocation grant message corresponding to a message to be transmitted to the terminal in a state in which a service request message and a BSR message are not received from the terminal; and receiving, by the base station, a message for call processing corresponding to the UL resource allocation grant message from the terminal.

### BRIEF DESCRIPTION OF DRAWINGS

Example embodiments of the present invention will become more apparent by describing in detail example embodiments of the present invention with reference to the accompanying drawings, in which:

FIG. 1 shows a data transmission procedure between a terminal and a base station in an IMT-advanced system;

FIG. 2 shows an attach procedure using the data transmission procedure between the terminal and the base station shown in FIG. 1;

FIG. 3 shows a state transition procedure from an idle state to an attached state of the terminal using the data transmission procedure between the terminal and the base station shown in FIG. 1;

FIG. 4 shows an attach procedure of the terminal according to an example embodiment of the present invention;

FIG. 5 shows an attach procedure of the terminal according to another example embodiment of the present invention;

FIG. 6 shows a state transition procedure from an idle state to an attached state of the terminal according to an example embodiment of the present invention;

FIG. 7 shows a state transition procedure from an idle state to an attached state of the terminal according to another example embodiment of the present invention;

FIG. 8 shows an example of a call processing procedure when an attach procedure is applied to a specific terminal according to an example embodiment of the present invention;

FIG. 9 shows another example of a call processing procedure when an attach procedure is applied to a specific terminal according to an example embodiment of the present invention; and

FIG. 10 shows a CE format to be used to recognize the specific terminal in the call processing procedure according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element, or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The term “terminal” may refer to a mobile station (MS), a mobile terminal (MT), user equipment (UE), a user terminal (UT), a wireless terminal, an access terminal (AT), a subscriber unit, a subscriber station (SS), a wireless device, a wireless communication device, a wireless transmit/receive unit (WTRU), a mobile node, a mobile, or other terms.

The term “base station” generally denotes a fixed point communicating with a terminal, and may be referred to as a Node-B, an evolved Node-B (eNB), a base transceiver system (BTS), an access point, and other terms.

Hereinafter, example embodiments of the present invention will be described in detail with reference to the accompanying drawings. To understand the invention easily, the same elements are designated using the same reference numerals, and redundant description thereof is omitted.

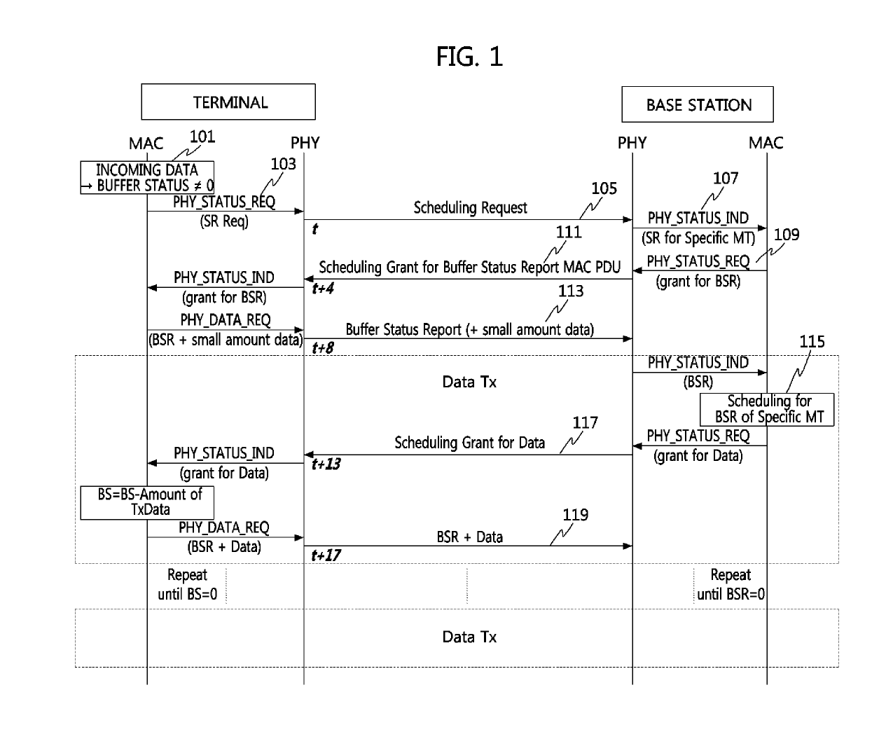

In an IMT-advanced system, a terminal performs a process of setting up a shared channel or uplink/downlink shared channel (UL/DL SCH) during a call setup procedure. After the setup of the UL SCH is completed, the terminal performs a procedure as shown in FIG. 1 so as to transmit data.

FIG. 1 shows a data transmission procedure between a terminal and a base station in an IMT-advanced system.

Referring to FIG. 1, first, if data to be transmitted by the terminal is generated (101), a MAC layer of the terminal requests a physical (PHY) layer to transmit a scheduling request (SR) to the base station (103). At this time, the terminal uses an SR prohibit timer so as to reduce unnecessary SR transmission. That is, the terminal starts up the SR prohibit timer after transmitting the SR to the base station once, and waits for a response to be received from the base station without retransmitting the SR before the timer expires.

The PHY layer of the terminal receiving the SR transmission request from the MAC layer waits for an appropriate time for the SR transmission to be reached. A time when the SR transmission is possible is determined by the base station, and various SR transmission cycles between 1 ms and 80 ms may be provided. If a cycle is reached, the PHY layer of the terminal transmits the SR (105). Here, the SR is transmitted to the base station through a physical uplink control channel (PUCCH), and the terminal uses a specific signal (for example, an SR PUCCH resource index) allocated from the base station to distinguish the terminal that transmits the SR.

The PHY layer of the base station receives the SR transmitted from the terminal and then transfers the SR to the MAC layer (107). The MAC layer of the base station allocates a radio resource scheduling grant through which data having a size predefined by a scheduler may be transmitted to know a buffer status of the terminal, and transfers the scheduling grant to the PHY layer (109). The PHY layer transmits the scheduling grant (scheduling grant for a BSR MAC PDU) allocated for a buffer status report (BSR) to the terminal (111).

Thereafter, the terminal receiving the scheduling grant transmitted from the base station creates a BSR MAC PDU for a size of data (buffer status) currently waiting for UL transmission, and transmits the BSR MAC PDU to the base station (113). At this time, when the size of a radio resource allocated by the base station is large to include another packet in addition to the BSR, the terminal may include and transmit UL data in the remaining radio resource.

The base station receiving buffer state information of the terminal allocates an UL radio resource according to the received buffer state information of the terminal (115), and transmits the allocated UL radio resource allocation information (scheduling grant for data) to the terminal (117). At this time, the base station allocates a radio resource size according to the amount of waiting UL data in the terminal, and allocates a resource until a buffer of the terminal is empty.

After receiving the radio resource allocation information transmitted from the base station, the terminal transmits data using an allocated radio resource (119). When data is transmitted, the terminal notifies the base station of the variation of the buffer state of the terminal by sending a BSR MAC PDU according to the variation of the buffer state.

As shown in FIG. 1, a time in which the terminal may transmit first data is about a period from a time t at which the first data is input to a buffer to about 17 ms(t+17) even if the SR prohibit timer or SR cycle of the terminal is not considered. When the SR prohibit timer or SR cycle of the terminal is considered, data delay having a maximum of about several tens of ms may be caused.

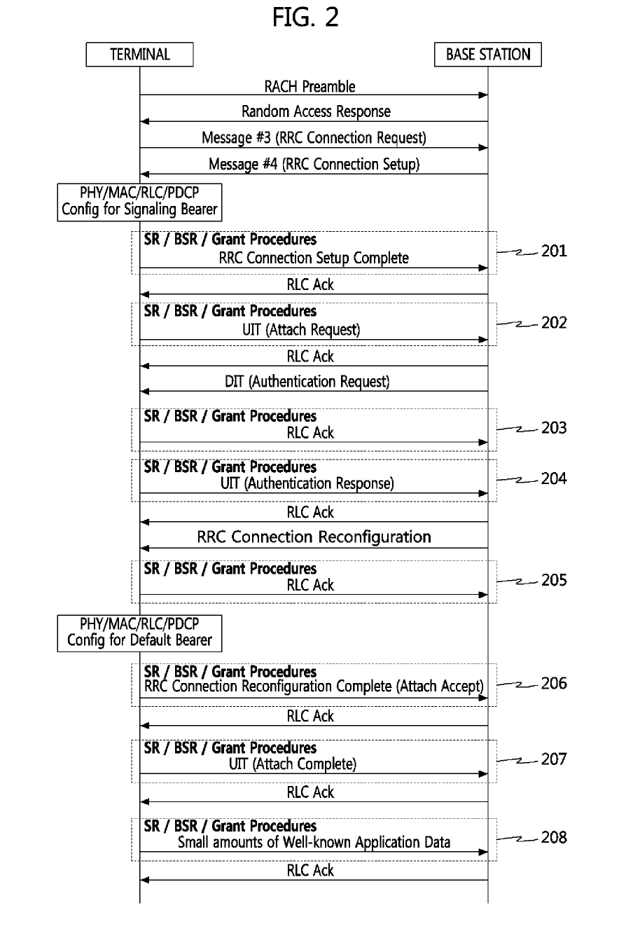

FIG. 2 shows an attach procedure using the data transmission procedure between the terminal and the base station shown in FIG. 1.

Referring to FIG. 2, the terminal performs a total of seven UL transmission processes of transmitting an RRC connection setup complete message 201, an attach request message 202, an RLC Ack message 203 for a downlink information transfer (DIT) including an authentication request message, an authentication response message 204, an RLC Ack message 205 for an RRC connection reconfiguration message, an RRC connection reconfiguration complete message 206, and an attach complete message 207. In this case, data transmission/reception processes for the SR, BSR, and scheduling grant as shown in FIG. 1 are performed and hence significant data delay is caused.

When data transmission characteristics in an offline state (that is, a non-attached state or a context deactivation state) of the MTC terminal are considered, application data transmission is performed after call processing ends. Accordingly, delay of several hundreds of ms is necessary even when the MTC terminal considers only UL transmission to sense and report a specific state.

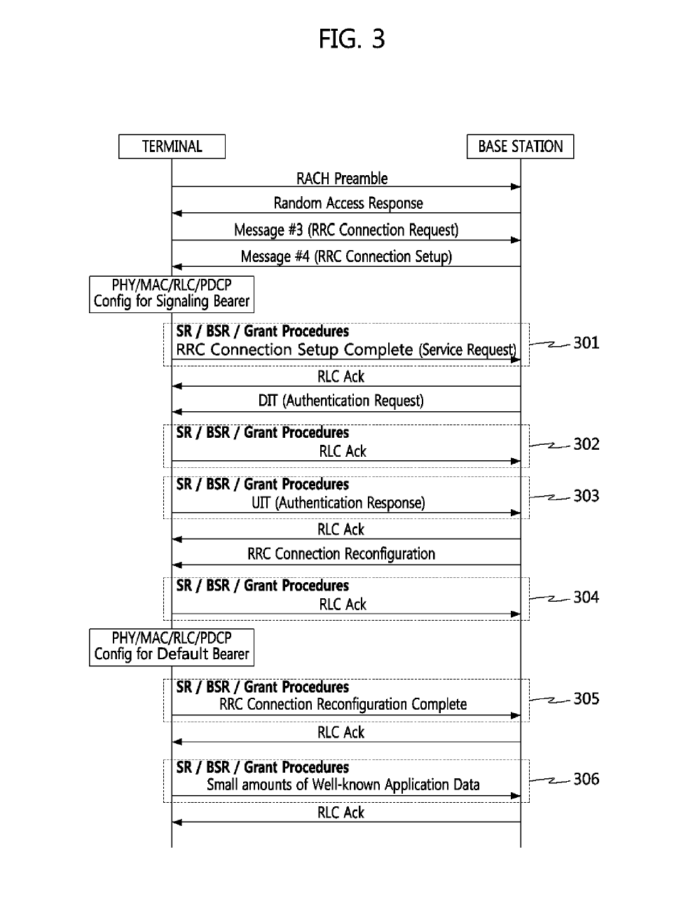

FIG. 3 shows a state transition procedure of the terminal using the data transmission procedure between the terminal and the base station shown in FIG. 1, and shows the state transition procedure when the terminal transitions from an idle state to an active state.

As shown in FIG. 3, when data is transmitted to the base station due to event occurrence during standby in an evolved packet system (EPS) mobility management (EMM) active/RRC idle state, not in the offline state (non-attached state), the MTC terminal needs to perform a total of six UL transmissions, that is, UL transmissions of an RRC connection setup complete message 301, an RLC Ack message 302 for DIT including an authentication request message, an authentication response message 303, an RLC Ack message 304 for an RRC connection reconfiguration message, an RRC connection reconfiguration complete message 305, and small amounts of well-known application data 306. In this case, data transmission/reception processes for the SR, BSR, and scheduling grant as shown in FIG. 1 are performed and hence significant data delay is caused.

Accordingly, when the MTC terminal considers only UL transmission to sense and report a specific state, delay of several hundreds of ms is necessary.

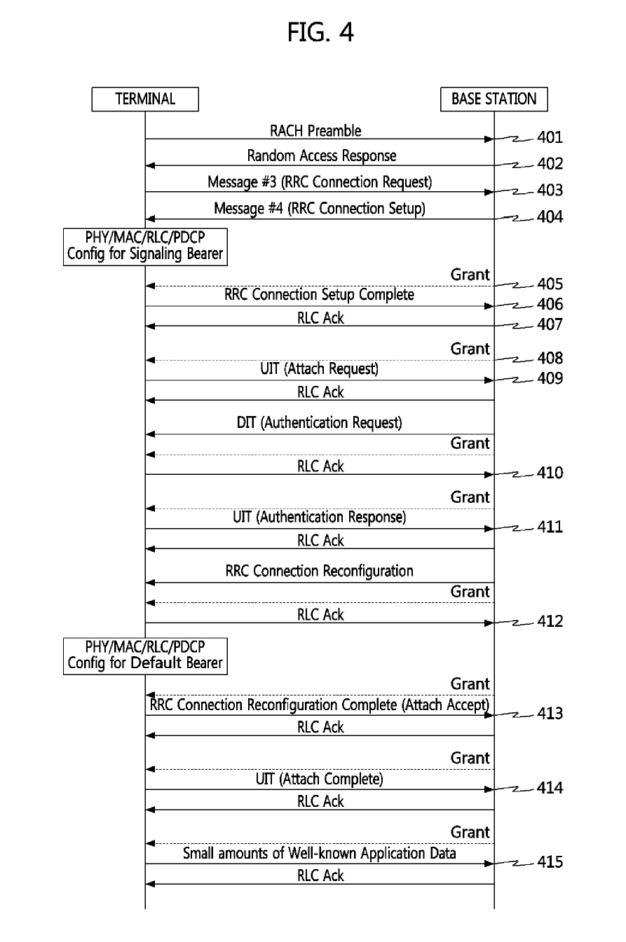

FIG. 4 shows an attach procedure of the terminal according to an example embodiment of the present invention.

FIG. 4 shows an attach procedure when the base station performs resource allocation for direct data transmission by omitting SR and BSR transmission processes of the terminal shown in FIGS. 1 to 3 in consideration of transmission characteristics of small amounts of well-known application data of the MTC terminal.

Referring to FIG. 4, first, the terminal transmits a random access channel (RACH) preamble to the base station (401), and receives a random access response message as its response from the base station (402). Thereafter, the terminal transmits an RRC connection request message to establish a connection to the base station (403), and the base station transmits an RRC connection setup message as its response to the terminal (404).

Thereafter, the base station transmits a grant message for UL resource allocation to the terminal without receiving an SR message and a BSR message from the terminal (405). Here, because the base station can estimate a message to be transmitted from the terminal and its transmission time after transmitting the RRC connection setup message to the terminal, the base station determines a transmission time of a grant message on the basis of the estimated content.

After transmitting the RRC connection setup message to the base station as described above, the terminal transmits an RRC connection setup complete message to the base station upon receipt of the grant message after waiting for the grant message to be received from the base station without performing the SR and BSR transmission processes shown in FIGS. 1 to 3 (406).

The base station receives the RRC connection setup complete message transmitted from the terminal and transmits an RLC Ack message as its response (407), and transmits a grant message (408). Here, because it is possible to estimate the next message to be transmitted by the terminal, the base station transmits a grant message for resource allocation corresponding to the estimated message.

Upon receipt of the grant message from the base station, the terminal transmits an attach request message for an attach request to the base station (409). That is, the terminal directly transmits the attach request message to the base station upon receipt of the grant message after waiting for the grant message to be received from the base station without performing SR and BSR transmission processes for transmitting the above-described attach request message.

Thereafter, the terminal directly transmits a message to the base station after waiting for the grant message to be received from the base station without performing the SR and BSR transmission processes as shown in FIGS. 1 to 3 even in a process of transmitting an RLC Ack message 410, an authentication response message 411, an RLC Ack message 412, an RRC connection reconfiguration complete message 413, an attach complete message 414, and small amounts of well-known application data 415.

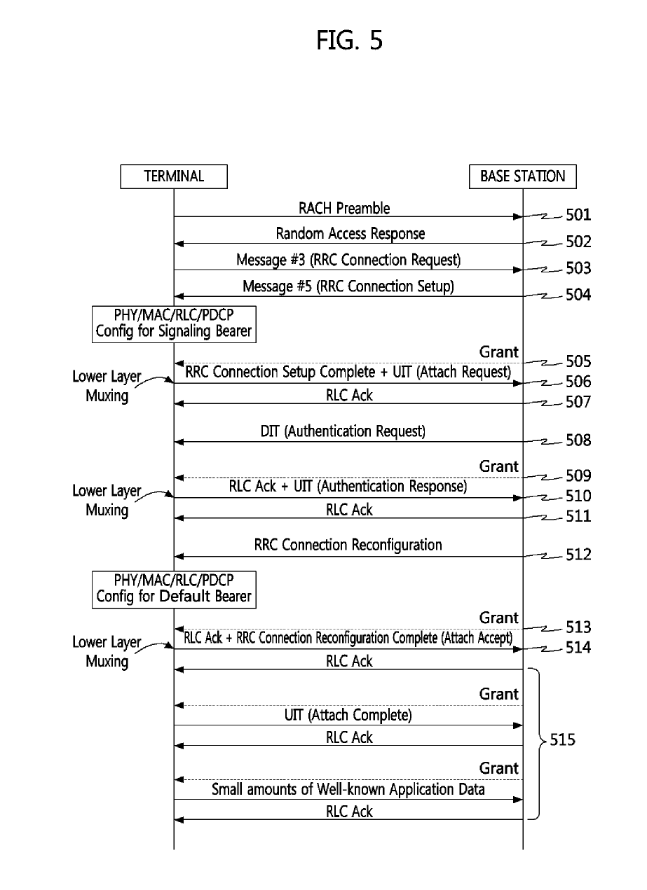

FIG. 5 shows an attach procedure of the terminal according to another example embodiment of the present invention.

FIG. 5 shows an example in which the base station adjusts a transmission time of a grant message, and the terminal receiving the grant message transmits a multiplexed message using a PDU multiplexing function in the MAC layer, thereby reducing the number of message transmissions through UL and further reducing delay time of call processing and application data transmission.

Referring to FIG. 5, first, the terminal transmits an RACH preamble to the base station (501), and receives a random access response message as its response from the base station (502). Thereafter, the terminal transmits an RRC connection request message to establish a connection to the base station (503), and the base station transmits an RRC connection setup message as its response to the terminal (504).

Thereafter, the base station transmits a grant message for UL resource allocation to the terminal without receiving an SR message and a BSR message from the terminal (505). Here, because the base station can estimate messages (for example, an RRC connection setup complete message and an attach request message) to be transmitted from the terminal after transmitting the RRC connection setup message, the base station transmits the grant message by allocating UL resources corresponding to the messages (that is, the RRC connection setup complete message and the attach request message) estimated to be transmitted by the terminal.

After transmitting the RRC connection setup message to the base station as described above, the terminal transmits a message into which the RRC connection setup complete message and the attach request message are multiplexed in the MAC layer to the base station upon receipt of the grant message after waiting for the grant message to be received from the base station (506).

The base station receives and de-multiplexes the RRC connection setup complete message and the attach request message multiplexed and transmitted by the terminal and transmits an RLC Ack message as their responses (507), and then transmits an authentication request message (508).

Thereafter, because the base station can estimate the next messages (for example, an RLC Ack message and an authentication response message) to be transmitted by the terminal receiving the authentication request message, the base station transmits a grant message for resource allocation corresponding to the messages (that is, the RLC Ack message and the authentication response message) estimated to be transmitted by the terminal to the terminal (509).

Upon receipt of the grant message after waiting for the grant message to be received from the base station, the terminal transmits a message into which the RLC Ack message and the authentication response message are multiplexed to the base station (510).

The base station receives and de-multiplexes the RLC Ack message and the authentication response message multiplexed and transmitted by the terminal, and then transmits an RLC Ack message as their responses and an RRC connection reconfiguration message to the terminal (511 and 512).

Thereafter, because the base station can estimate the next messages (for example, an RLC Ack message and an RRC connection reconfiguration complete message) to be transmitted by the terminal receiving the RRC connection reconfiguration message, the base station transmits a grant message for resource allocation corresponding to the messages (that is, the RLC Ack message and the RRC connection reconfiguration complete message) estimated to be transmitted by the terminal to the terminal (513).

Upon receipt of the grant message after waiting for the grant message to be received from the base station, the terminal transmits a message into which the RLC Ack message and the RRC connection reconfiguration complete message are multiplexed to the base station (514).

A subsequent processing procedure (515) is the same as shown in FIG. 4.

As shown in FIG. 5, in the attach procedure according to another example embodiment of the present invention, the base station transmits a grant message at a certain point in time by allocating an UL resource corresponding to messages to be multiplexed and transmitted by the terminal, and the terminal receiving the grant message from the base station multiplexes a PDU of a message to be transmitted through UL in the MAC layer, and transmits the multiplexed PDU to the base station. Accordingly, the terminal may perform a rapid and efficient attach procedure by omitting SR and BSR transmission processes performed in the attach procedure of the related art, and multiplexing and directly transmitting data to be transmitted.

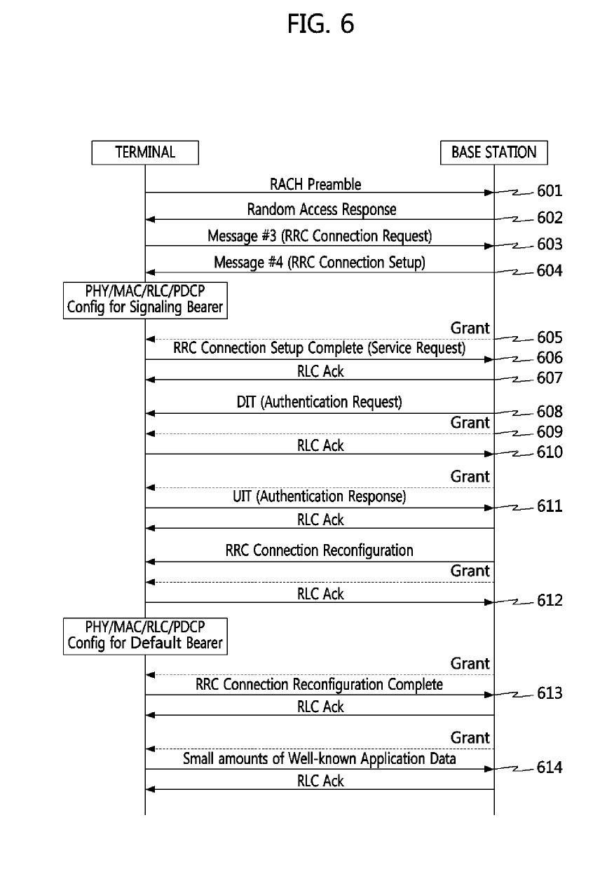

FIG. 6 shows a state transition procedure of the terminal according to an example embodiment of the present invention, and shows an example of a call processing procedure between the terminal and the base station when the terminal transitions from an idle state to an active state.

As shown in FIG. 6, when data is transmitted to the base station due to event occurrence during standby in an EMM active/RRC idle state, the terminal (for example, the MTC terminal) first transmits an RACH preamble to the base station (601), and receives a random access response message as its response from the base station (602). Thereafter, the terminal transmits an RRC connection request message for establishing a connection to the base station (603), and the base station transmits an RRC connection setup message as its response to the terminal (604).

Thereafter, the base station transmits a grant message for UL resource allocation to the terminal without receiving an SR message and a BSR message from the terminal (605). Here, because the base station can estimate a message (for example, an RRC connection setup complete message) to be transmitted from the terminal and its transmission time after transmitting the RRC connection setup message to the terminal, the base station transmits the grant message to the terminal by allocating a UL resource corresponding to the message (that is, the RRC connection setup complete message) estimated to be transmitted by the terminal.

After transmitting the RRC connection setup message to the base station, the terminal transmits an RRC connection setup complete message to the base station upon receipt of a grant message after waiting for the grant message to be received from the base station without performing the SR and BSR transmission processes as in the related art (606).

The base station receives the RRC connection setup complete message transmitted from the terminal and transmits an RLC Ack message as its response (607), and then transmits an authentication request message (608).

Thereafter, because the base station can estimate the next message (for example, an RLC Ack message) to be transmitted by the terminal receiving the authentication request message, the base station transmits a grant message for resource allocation corresponding to the message (that is, the RLC Ack message) estimated to be transmitted by the terminal (609).

Upon receipt of the grant message from the base station, the terminal transmits the RLC Ack message to the base station using an allocated UL resource (610).

Thereafter, the terminal directly transmits a message to the base station after waiting for the grant message to be received from the base station without performing the SR and BSR transmission processes as in the related art even in a process of transmitting an authentication response message 611, an RLC Ack message 612, an RRC connection reconfiguration complete message 613, and small amounts of well-known application data 614.

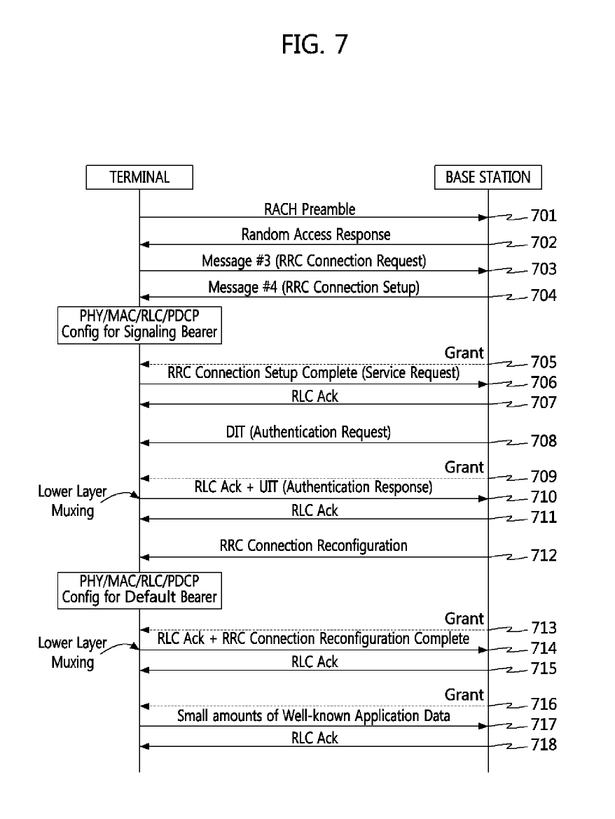

FIG. 7 shows a state transition procedure of the terminal according to another example embodiment of the present invention, and shows an example in which the base station adjusts a grant message transmission time, and the terminal receiving the grant message transmits a multiplexed message using a PDU multiplexing function in the MAC layer when the terminal (for example, the MTC terminal) transmits data to the base station due to event occurrence during standby in an EMM active/RRC idle state, thereby further reducing delay time of call processing and application data transmission.

Referring to FIG. 7, the terminal first transmits an RACH preamble to the base station (701), and receives a random access response message as its response from the base station (702). Thereafter, the terminal transmits an RRC connection request message for establishing a connection to the base station (703), and the base station transmits an RRC connection setup message as its response to the terminal (704).

Thereafter, the base station transmits a grant message for UL resource allocation to the terminal without receiving an SR message and a BSR message from the terminal (705). Here, because the base station can estimate a message (for example, an RRC connection setup complete message) to be transmitted from the terminal after transmitting the RRC connection setup message to the terminal, the base station transmits the grant message by allocating a UL resource corresponding to the message (that is, the RRC connection setup complete message) estimated to be transmitted by the terminal.

After transmitting the RRC connection setup message to the base station as described above, the terminal transmits the RRC connection setup complete message to the base station upon receipt of the grant message after waiting for the grant message to be received from the base station (706).

After receiving the RRC connection setup complete message transmitted from the terminal and transmitting an RLC Ack message as its response (707), the base station transmits an authentication request message (708).

Thereafter, because the base station can estimate the next messages (for example, an RLC Ack message and an authentication response message) to be transmitted by the terminal receiving the authentication request message, the base station transmits a grant message for resource allocation corresponding to the messages (that is, the RLC Ack message and the authentication response message) estimated to be transmitted by the terminal to the terminal (709).

Upon receipt of a grant message after waiting for the grant message to be received from the base station, the terminal transmits a message into which the RLC Ack message and the authentication response message are multiplexed to the base station (710).

The base station receives and de-multiplexes the RLC Ack message and the authentication response message multiplexed and transmitted by the terminal, and then transmits an RLC Ack message as their responses and an RRC connection reconfiguration message to the terminal (711 and 712).

Thereafter, because the base station can estimate the next messages (for example, an RLC Ack message and an RRC connection reconfiguration complete message) to be transmitted by the terminal receiving the RRC connection reconfiguration message, the base station transmits a grant message for resource allocation corresponding to the messages (that is, the RLC Ack message and the RRC connection reconfiguration complete message) estimated to be transmitted by the terminal to the terminal (713).

Upon receipt of a grant message after waiting for the grant message to be received from the base station, the terminal transmits a message into which the RLC Ack message and the RRC connection reconfiguration complete message are multiplexed to the base station (714).

The base station receives and de-multiplexes the RLC Ack message and the RRC connection reconfiguration complete message multiplexed by the terminal, and transmits an RLC Ack message as their responses to the terminal (715).

Thereafter, the base station transmits a grant message to the terminal by allocating an UL resource corresponding to data to be transmitted by the terminal (716), the terminal receiving the grant message transmits small amounts of well-known application data to the base station using the allocated resource (717), and the base station transmits an RLC Ack message as their responses to the terminal (718).

The call processing procedure according to the example embodiment of the present invention as shown in FIGS. 4 and 7 may be applied to call processing processes of all terminals, or may be applied to only a call processing process of a specific terminal.

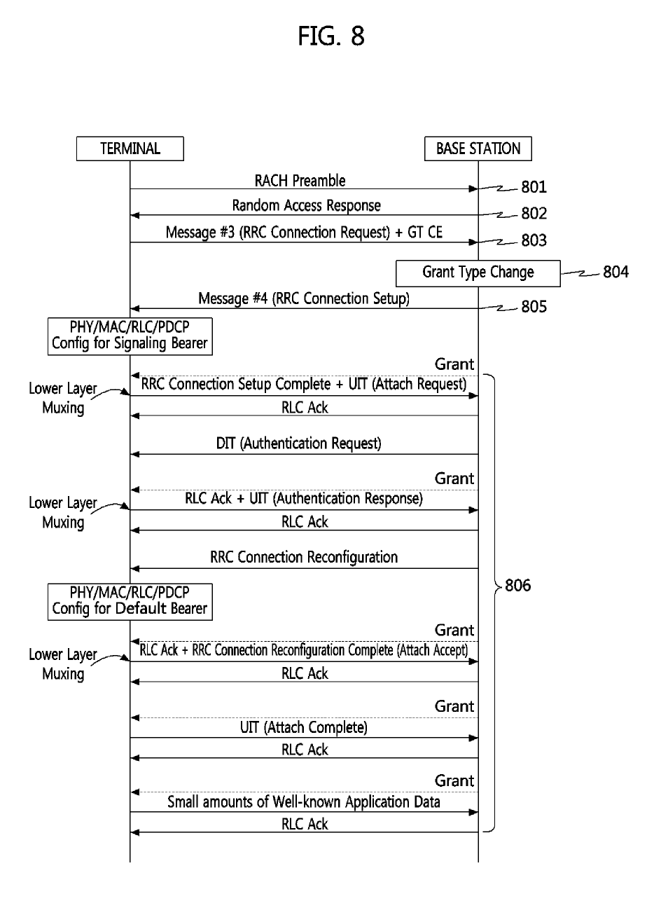

FIG. 8 shows an example of a call processing procedure when an attach procedure is applied to a specific terminal according to an example embodiment of the present invention.

FIG. 8 shows an example of a process in which the specific terminal, which performs the attach procedure according to the example embodiment of the present invention, transfers information from which the base station may identify the specific terminal in the form of a MAC CE PDU to the base station, and the base station changes a grant type on the basis of the information.

Referring to FIG. 8, first, the terminal transmits an RACH preamble to the base station (801), and receives a random access response message as its response from the base station (802).

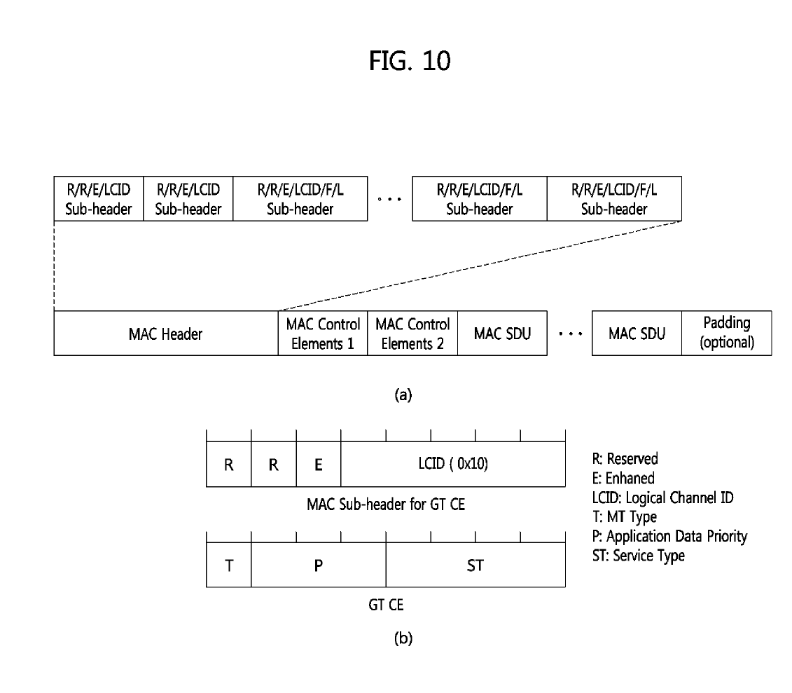

Thereafter, the terminal transmits an RRC connection request message and a grant type (GT) CE so as to establish a connection to the base station (803). Here, the GT CE is configured in the form of a MAC CE PDU, and may include terminal type information, application data priority information, and service type information as described later with reference to FIG. 10.

After receipt of the RRC connection request message and the GT CE transmitted from the terminal, the base station changes the call processing procedure associated with the terminal on the basis of information of the terminal included in the GT CE as in the above-described embodiment of the present invention (804), and pre-applies quality of service (QoS) information such as application data transmission priority or delay requirement of the terminal, or the like before call setup completion.

Thereafter, the base station transmits an RRC connection setup message to the terminal as a response to the RRC connection request message transmitted from the terminal (805).

Because a subsequent attach procedure (806) is the same as in reference numerals 505 to 515 shown in FIG. 5, redundant description thereof is omitted.

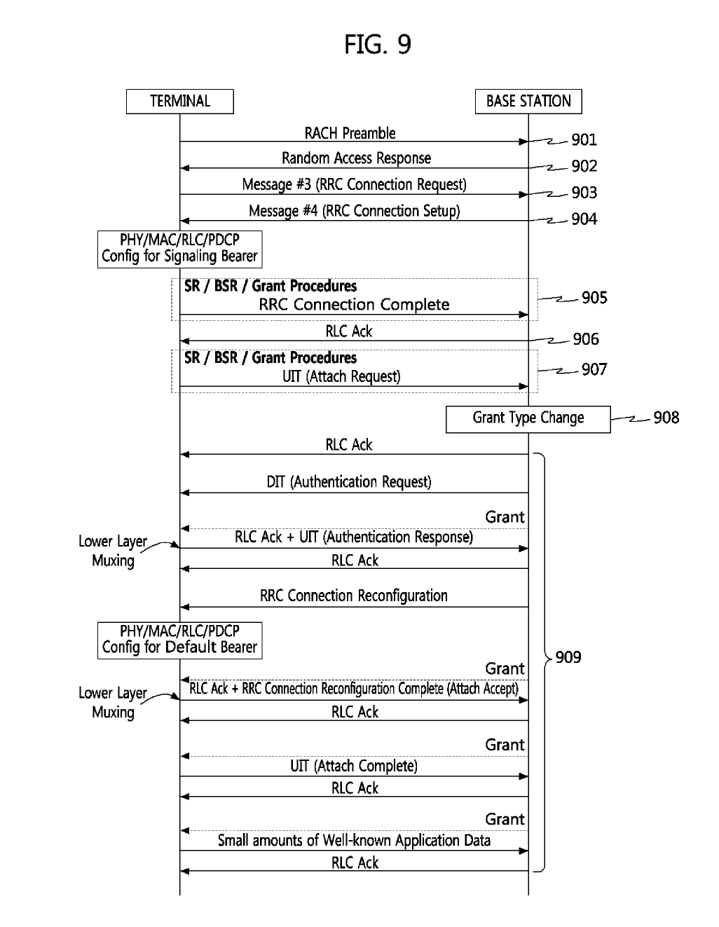

FIG. 9 shows another example of a call processing procedure when an attach procedure is applied to a specific terminal according to an example embodiment of the present invention.

FIG. 9 shows an example of a process in which the base station changes a grant type on the basis of general information from the terminal when the specific terminal, which performs the attach procedure according to the example embodiment of the present invention, does not transmit separate information for identifying the specific terminal.

Referring to FIG. 9, first, the terminal transmits an RACH preamble to the base station (901), and receives a random access response message as its response from the base station (902).

Thereafter, the terminal receives an RRC connection request message for establishing a connection to the base station (903), and the base station transmits an RRC connection setup message as its response to the terminal (904).

Thereafter, the terminal transmits an RRC connection setup complete message to the base station after performing SR, BSR, and grant procedures with the base station as shown in FIGS. 1 and 2 (905), and the base station transmits an RLC Ack message as its response to the terminal (906).

In addition, the terminal transmits an attach request message to the base station after performing the SR, BSR, and grant procedures with the base station (907).

The base station acquires a terminal type, a service type, packet priority, and the like on the basis of information of an international mobile subscriber identity (IMSI), a serving-temporary mobile subscriber identity (S-TMSI), and the like included in messages transmitted from the terminal, and changes the call processing procedure with the terminal on the basis of the acquired information as in the above-described example embodiment of the present invention (908).

Because a subsequent attach procedure (909) is the same as in reference numerals 507 to 515 shown in FIG. 5, redundant description thereof is omitted.

FIG. 10 shows a CE format to be used to recognize a specific terminal in the call processing procedure according to an example embodiment of the present invention.

FIG. 10(a) shows an example of a MAC PDU including a MAC header, CEs, SDUs, and Padding and FIG. 10(b) shows configurations of a GT CE and a MAC sub-header for a GT CE.

As shown in FIG. 10(b), the GT CE may include fields indicating terminal type (MT), application data priority (P), and service type (T).

According to the call processing method for use in the MTC terminal as described above, general SR, grant, BSR, and data transmission procedures for UL data transmission of the terminal are simplified, so that it is possible to rapidly and efficiently perform a call processing procedure as compared with that of the related art, and lengthen the life span of the terminal by reducing power consumption of the terminal that uses a battery as an energy source.

While the example embodiments of the present invention and their advantages have been described in detail, it should be understood that various changes, substitutions and alterations may be made herein without departing from the scope of the invention.

What is claimed is:

1. A call processing method for use in a machine-type communication (MTC) terminal in a wireless communication network for providing an MTC service, comprising:
transmitting, by a terminal, a radio resource control (RRC) connection request message to a base station;
receiving, by the terminal, an RRC connection setup message from the base station;
receiving, by the terminal, an uplink (UL) resource allocation grant message from the base station in a state in which a service request message and a buffer status report (BSR) message are not transmitted to the base station; and
transmitting, by the terminal, a message for call processing corresponding to the UL resource allocation grant message.

2. The call processing method of claim 1, wherein the UL resource allocation grant message includes UL resource allocation information corresponding to a message estimated by the base station as a message to be transmitted by the terminal.

3. The call processing method of claim 1, wherein the receiving of the UL resource allocation grant message from the base station includes:
receiving, by the terminal, the UL resource allocation grant message from the base station before one of an RRC connection setup complete message, an attach request message, a radio link control (RLC) acknowledgement (Ack) message, an authentication response message, an RRC connection reconfiguration complete message, an attach complete message, and application data, is transmitted.

4. The call processing method of claim 1, wherein the UL resource allocation grant message includes UL resource allocation information corresponding to messages estimated by the base station as messages to be multiplexed and transmitted by the terminal.

5. The call processing method of claim 1, wherein the transmitting of the message for the call processing includes:
multiplexing, by the terminal, at least two messages among messages to be sequentially transmitted to the base station for the call processing in a medium access control (MAC) layer; and
transmitting the multiplexed messages to the base station.

6. The call processing method of claim 1, wherein the transmitting, by the terminal, of the RRC connection request message to the base station includes:
including and transmitting control element (CE) information including information from which the base station identifies the terminal.

7. The call processing method of claim 6, wherein the CE information includes at least one piece of terminal type information, application data priority information, and service type information, and is configured in the form of a MAC CE protocol data unit (PDU).

8. A call processing method for use in an MTC terminal in a wireless communication network for providing an MTC service, comprising:
receiving, by a base station, an RRC connection request message from a terminal;
transmitting, by the base station, an RRC connection setup message to the terminal;
transmitting, by the base station, a UL resource allocation grant message corresponding to a message to be transmitted to the terminal in a state in which a service request message and a BSR message are not received from the terminal; and
receiving, by the base station, a message for call processing corresponding to the UL resource allocation grant message from the terminal.

9. The call processing method of claim 8, wherein the transmitting of the UL resource allocation grant message to the terminal includes:
estimating, by the base station, a predetermined message to be transmitted by the terminal, allocating a UL resource corresponding to the estimated predetermined message, and transmitting the UL resource allocation grant message to the terminal.

10. The call processing method of claim 8, wherein the transmitting of the UL resource allocation grant message to the terminal includes:
transmitting, by the terminal, one of an RRC connection setup complete message, an attach request message, an RLC Ack message, an authentication response message, an RRC connection reconfiguration complete message, an attach complete message, and application data for UL resource allocation.

11. The call processing method of claim 8, wherein the transmitting of the UL resource allocation grant message to the terminal includes:
estimating, by the base station, messages to be multiplexed and transmitted by the terminal, and transmitting the UL resource allocation grant message including UL resource allocation information corresponding to the estimated messages to be multiplexed and transmitted to the terminal.

12. The call processing method of claim 8, wherein the receiving, by the base station, of the RRC connection request message from the terminal includes:
receiving, by the base station, the RRC connection request message and CE information including information from which the base station identifies the terminal.

13. The call processing method of claim 12, wherein the CE information includes at least one piece of terminal type information, application data priority information, and service type information, and is configured in the form of a MAC CE PDU.

14. The call processing method of claim 8, further comprising:
acquiring at least one piece of terminal type information, service type information, and packet priority information on the basis of subscriber information included in at least one message transmitted from the terminal before the UL resource allocation grant message is transmitted to the terminal; and
transmitting the UL resource allocation grant message to the terminal on the basis of the acquired at least one information piece.
